(19) United States
(12) Patent Application Publication
(10) Pub. No.: US 2009/0023854 A1
(43) Pub. Date: Jan. 22, 2009

(54) WATER-BASED INK FOR INKJET PRINTING

(75) Inventors: Nobuyuki Takizawa, Wakayama (JP); Akira Umada, Wakayama (JP); Nobushige Tanaka, Wakayama (JP); Takehiro Tsutsumi, Wakayama (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KAO CORPORATION, TOKYO (JP)

(21) Appl. No.: 11/718,347

(22) PCT Filed: Nov. 1, 2005
(86) PCT No.: PCT/JP05/20404

§ 371 Date: Mar. 10, 2008

(30) Foreign Application Priority Data
Nov. 2, 2004 (JP) 2004-319271

(51) Int. Cl. C08L 33/10; C08K 3/04; C09D 11/10

(52) U.S. Cl. 524/502; 524/558

(57) ABSTRACT

A water dispersion for inkjet printing, which contains water-insoluble polymer particles containing a colorant. The content of the water-insoluble polymer in the water dispersion is from 1 to 7% by weight, and the surface tension of the water dispersion is 60 mN/m or higher at 20° C. A water-based ink for inkjet printing which contains the water dispersion produces printed images with a high optical density and a good color-to-color bleed resistance.

### TECHNICAL FIELD

The present invention relates to a water dispersion for inkjet printing, a process for producing the water dispersion, and a water-based ink for inkjet printing containing the water dispersion.

### BACKGROUND ART

In inkjet printings, droplets of ink are directly projected onto a recording medium from very fine nozzles and allowed to adhere to the recording medium, to form printed images. The inkjet printings have been rapidly spread because of their various advantages such as easiness of full colorization, low costs, capability of using ordinary paper as the recording medium, non-contact with printed images, etc.

Among the printing methods, in view of enhancing the lightfastness and the water resistance of printed images, an inkjet printing method utilizing an ink containing a pigment as the colorant has now come to dominate. For example, WO 00/39226 discloses a water-based ink containing a vinyl polymer containing a pigment. To attain a high optical density, a graft polymer obtained from a macromer is used as the vinyl polymer. JP 2002-121460A discloses a polymer-free aqueous dispersion containing a pigment and a pigment derivative.

However, the proposed pigment-containing, water-based inks are still insufficient in the optical density, and also insufficient in preventing a color-to-color bleed at borders between different colors which are deposited on a print medium with a time lag.

### DISCLOSURE OF INVENTION

The present invention relates to a water dispersion for inkjet printing which contains water-insoluble polymer particles containing a colorant, wherein a content of the water-insoluble polymer in the water dispersion is from 1 to 7% by weight, and a surface tension of the water dispersion is 60 mN/m or higher at 20° C., and also relates to a water-based ink for inkjet printing containing such a water dispersion.

The present invention further relates to a process for producing a water dispersion for inkjet printing which includes steps of:
(1) synthesizing a water-insoluble polymer by solution polymerization;
(2) cleaning the water-insoluble polymer obtained in the step 1 with a solvent;
(3) mixing at least the water-insoluble polymer obtained in the step 2, a colorant, an organic solvent and water, and then subjecting a resulting mixture to a dispersing treatment, to form a dispersion of water-insoluble polymer particles containing the colorant; and
(4) removing the organic solvent from the dispersion obtained in the step 3.

### BEST MODE FOR CARRYING OUT THE INVENTION

The present invention relates to a water dispersion for inkjet printing which produces printed images with a high optical density and is excellent in a color-to-color bleed resistance, and also relates to a water-based ink for inkjet printing containing the water dispersion.

The inventors have found that the penetration of the water-insoluble polymer particles containing a colorant into a print medium and the color-to-color bleed can be effectively controlled by regulating the surface tension of the water dispersion.

The water dispersion for inkjet printing of the present invention contains from 1 to 7% by weight (solid basis) of the water-insoluble polymer and has a surface tension of 60 mM/m or higher at 20° C. The components of the water dispersion will be described below.
(I) Water-Insoluble Polymer

The water-insoluble polymer for constituting the water-insoluble polymer particles may be selected from water-insoluble vinyl polymers, water-insoluble ester polymers and water-insoluble urethane polymers, with the water-insoluble vinyl polymers being preferred because of their good dispersion stability and ease of synthesis. The water-insoluble polymer referred to herein means polymers having a solubility of preferably 10 g or less, more preferably 5 g or less and still more preferably one gram or less when dissolved into 100 g of water at 25° C. after dried at 105° C. for 2 h. When the water-insoluble polymer has a salt-forming group, the solubility is measured on a polymer after neutralizing 100% of the salt-forming groups with acetic acid or sodium hydroxide which is selected according to the types of the salt-forming groups.

The water-insoluble polymer is preferably a water-insoluble graft polymer including (a) constitutional units derived from a monomer having a salt-forming group, (b) constitutional units derived from a macromer and (c) constitutional units derived from a hydrophobic monomer because of its good storage stability.

Such a water-insoluble graft polymer is preferably a water-insoluble vinyl polymer produced by the copolymerization of a monomer mixture containing (a) a monomer having a salt-forming group (also called “component A”), (b) a macromer (also called “component B”), and (c) a hydrophobic monomer (also called “component C”). The monomer mixture containing the components A, B and C may be hereinafter referred to simply as “monomer mixture.”

The component A is used to enhance the dispersion stability of resulting dispersions and may be cationic or anionic. Monomers described in JP 9-286939A, page 5, line 24 of column 7 to line 29 of column 8 are usable. Examples of the salt-forming groups include carboxyl group, sulfonic acid group, phosphoric acid group, amino group and ammonium group.

Examples of the cationic monomers include amine-containing unsaturated monomers and ammonium salt-containing unsaturated monomers, with N,N-dimethylaminoethyl (meth)acrylate and N-(N′,N′-dimethylaminopropyl) (meth)acrylamide being preferred.

Examples of the anionic monomers include unsaturated carboxylic acid monomers, unsaturated sulfonic acid monomers and unsaturated phosphoric acid monomers.

Examples of the unsaturated carboxylic acid monomers include acrylic acid, methacrylic acid, crotonic acid, itaconic acid, maleic acid, fumaric acid, citraconic acid and 2-methacryloyloxymethylsuccinic acid. Examples of the unsaturated sulfonic acid monomers include styrenesulfonic acid, 2-acrylamido-2-methylpropanesulfonic acid, 3-sulfopropyl (meth)acrylate and bis(3-sulfopropyl) itaconate. Examples of the unsaturated phosphoric acid monomers include vinylphosphonic acid, vinyl phosphate, bis(methacryloxyethyl) phosphate, diphenyl-2-acryloyloxyethyl phosphate, diphenyl-2-methacryloyloxyethyl phosphate and dibutyl-2-acryloyloxyethyl phosphate. To attain good dispersion stability and jetting properties, preferred as the anionic monomers are unsaturated carboxylic acid monomers, and more preferred are acrylic acid and methacrylic acid.

The component A may be used singly or in combination of two or more.

Examples of the macromers as the component B include (b-1) styrene-based macromers, (b-2) alkyl (meth)acrylate-based macromers, (b-3) aromatic ring-containing, (meth)acrylate-based macromers, and (b-4) silicone-based macromers, which are described below.

(b-1) Styrene-Based Macromer

The styrene-based macromer is a macromer derived from a styrene-based monomer (monomer B-1) such as styrene, α-methylstyrene and vinyltoluene, with styrene being preferred.

Examples of the styrene-based macromers include homopolymers of the monomer B-1 and copolymers of the monomer B-1 with another comonomer, each of the homopolymers and copolymers having a polymerizable functional group at one end. Acryloyloxy group and methacryloyloxy group are preferred as the polymerizable functional group. By copolymerizing such a macromer, a water-insoluble graft polymer including the constitutional units derived from the styrene-based macromer can be obtained.

Examples of comonomers include (1) acrylonitrile, (2) (meth)acrylic acid esters (monomer B-2) which will be described later, and (3) (meth)acrylate-based monomers having an aromatic ring other than styrene ring (monomer B-3).

To attain a sufficient rubbing resistance, the content of the constitutional units derived from the monomer B-1 in the styrene-based macromer is preferably 60% by weight or more, more preferably 70% or more and still more preferably 90% by weight or more.

The styrene-based macromers are commercially available, for example, under the trade names of AS-6, AS-6S, AN-6, AN-6S, HS-6 and HS-6S of Toagosei Co., Ltd.

(b-2) Alkyl (meth)acrylate-Based Macromer

The alkyl (meth)acrylate-based macromer is a macromer derived from a (meth)acrylic acid ester (monomer B-2) having a C₁₋₂₂, preferably C₁₋₁₈ alkyl group which may have a hydroxyl group.

Examples of the monomer B-2 include methyl (meth)acrylate, ethyl (meth)acrylate, (iso)propyl (meth)acrylate, 2-hydroxyethyl (meth)acrylate, (iso or tert-)butyl (meth)acrylate, 2-ethylhexyl (meth)acrylate, (iso)octyl (meth)acrylate, (iso)decyl (meth)acrylate and (iso)stearyl (meth)acrylate.

The side chain of the graft polymer, which includes constitutional units derived from the monomer B-2, can be introduced by the copolymerization of the alkyl (meth)acrylate-based macromer having a polymerizable functional group at its one end. Such macromers may include methyl methacrylate-based macromers, butyl acrylate-based macromers, isobutyl methacrylate-based macromers and lauryl methacrylate-based macromers.

The alkyl (meth)acrylate-based macromer may include homopolymers of the monomer B-2 and copolymers of the monomer B-2 with another comonomer, each of the homopolymers and copolymers having a polymerizable functional group at one end. Acryloyloxy group and methacryloyloxy group are preferred as the polymerizable functional group. Examples of the comonomers include (1) the styrene-based monomers (monomer B-1) and (3) (meth)acrylate-based monomers having an aromatic ring other than styrene ring (monomer B-3) to be described below.

The content of the constitutional units derived from the monomer B-2 in the alkyl (meth)acrylate-based macromer is higher than those of the other kinds of constitutional units. To attain a sufficient rubbing resistance, the content is preferably 60% by weight or more, more preferably 70% or more and still more preferably 90% by weight or more.

(b-3) Aromatic Ring-Containing, (meth)acrylate-Based Macromer

The aromatic ring-containing, (meth)acrylate-based macromer is a macromer derived from an aromatic ring-containing, (meth)acrylate-based monomer (monomer B-3).

Examples of the monomer B-3 include benzyl (meth)acrylate, phenoxyethyl (meth)acrylate, 2-hydroxy-3-phenoxypropoyl (meth)acrylate and 2-methacryloyloxyethyl 2-hydroxypropyl phthalate, with benzyl (meth)acrylate being preferred.

The side chain of the graft polymer including the constitutional units derived form the monomer B-3 can be introduced by the copolymerization of the aromatic ring-containing, (meth)acrylate-based macromer having a polymerizable functional group at one end.

Examples of such macromers include homopolymers of the monomer B-3 and copolymers of the monomer B-3 with another comonomer, each of the homopolymers and copolymers having a polymerizable functional group at one end. Acryloyloxy group and methacryloyloxy group are preferred as the polymerizable functional group. Examples of the comonomers include (1) the styrene-based monomers (monomer B-1) and (2) the (meth)acrylic acid esters (monomer B-2).

The content of the constitutional units derived from the monomer B-3 in the aromatic ring-containing, (meth)acrylate-based macromer is higher than those of the other kinds of constitutional units. The content is preferably 60% by weight or more, more preferably 70% or more and still more preferably 90% by weight or more.

(b-4) Silicon-Based Macromer

The side chain of the water-insoluble graft polymer may be an organopolysiloxane chain. Such a side chain can be introduced, for example, by the copolymerization of a silicone-based macromer having a polymerizable functional group at one end, which is preferably represented by the following formula 1:

CH₂═C(CH₃)—COOC₃H₆—[Si(CH₃)₂—O]t—Si(CH₃)₃ (1)

wherein the subscript t is a number of from 8 to 40.

When the polymer used is the water-insoluble graft polymer, the weight ratio of main chain/side chain is preferably from 1/1 to 20/1, more preferably from 3/2 to 15/1 and still more preferably from 2/1 to 10/1 in order to improve the bleed resistance and storage stability. For the purpose of calculating the weight ratio, the weight of polymerizable functional group is included in the weight of the side chain (the same applies below).

Among the above macromers, to improve the storage stability, the styrene-based macromers having a polymerizable functional group at one end are preferable because of their high affinity with the colorant.

The number-average molecular weight of the component B can be measured by gel permeation chromatography calibrated by a standard polystyrene, using tetrahydrofuran containing 50 mmol/L acetic acid as the eluent.

The component B is used to enhance the dispersion stability of water-insoluble polymer particles containing a colorant, and preferably a polymerizable unsaturated group-containing macromer having a number-average molecular weight of preferably from 500 to 100,000 and more preferably from 1,000 to 10,000.

The component C is used to improve the water resistance, rubbing resistance, bleed resistance, highlighter-fastness (degree of blur of printed images when traced with an aqueous fluorescent pen) and gloss, and may include alkyl (meth)acrylates, alkyl (meth)acrylamides and aromatic ring-containing monomers.

Examples of the alkyl (meth)acrylates include (meth)acrylic acid esters having an alkyl group of from 1 to 22 carbon atoms such as methyl (meth)acrylate, ethyl (meth)acrylate, (iso)propyl (meth)acrylate, (iso or tert-)butyl (meth)acrylate, (iso)amyl (meth)acrylate, cyclohexyl (meth)acrylate, 2-ethylhexyl (meth)acrylate, (iso)octyl (meth)acrylate, (iso)decyl (meth)acrylate, (iso)dodecyl (meth)acrylate and (iso)stearyl (meth)acrylate.

Examples of the alkyl (meth)acrylamides include (meth)acrylamides having an alkyl group of from 1 to 22 carbon atoms such as N,N-dimethyl(meth)acrylamide, N, N-diethyl(meth) acrylamide, N,N-dibutyl(meth)acrylamide, N-t-butyl(meth)acrylamide, N-octyl(meth)acrylamide and N-dodecyl(meth)acrylamide.

Examples of the aromatic ring-containing monomers include vinyl monomers having an aromatic hydrocarbon group of from 6 to 22 carbon atoms such as styrene, 2-methylstyrene, vinyltoluene, ethylvinylbenzene, 4-vinylbiphenyl, 1,1-diphenylethylene, benzyl (meth)acrylate, phenoxyethyl (meth)acrylate, vinylnaphthalene and chlorostyrene.

The term “(iso or tert-)alkyl” means isoalkyl, tert-alkyl or n-alkyl, and the term “(iso)alkyl” means isoalkyl or n-alkyl. The term “(meth)acrylate” means acrylate or methacrylate.

To improve the water resistance and bleed resistance, the component C is preferably at least one compound selected from the group consisting of alkyl (meth)acrylates and aromatic ring-containing monomers, and more preferably at least one compound selected from aromatic ring-containing monomers.

To improve the optical density and bleed resistance, the component C is also preferably a styrene-based monomer (component C-1), and more preferably styrene or 2-methylstyrene. The content of the component C-1 in the component C is preferably from 10 to 100% by weight and more preferably from 20 to 80% by weight, because the optical density and bleed resistance can be more improved.

To improve the gloss of the water-based ink, also preferred as the component C is an aryl ester of (meth)acrylic acid (component C-2). Examples thereof include arylalkyl esters of (meth)acrylic acid having an arylalkyl group of from 7 to 22 carbon atoms, preferably from 7 to 18 carbon atoms and more preferably from 7 to 12 carbon atoms and aryl esters of (meth)acrylic acid having an aryl group of from 6 to 22 carbon atoms, preferably from 6 to 18 carbon atoms and more preferably from 6 to 12 carbon atoms. Specific examples thereof include benzyl (meth)acrylate and phenoxyethyl (meth)acrylate. To improve the gloss, the content of the component C-2 in the component C is preferably from 10 to 100% by weight and more preferably from 20 to 80% by weight.

The component C may be used singly or in combination of two or more. It is also preferable to combinedly use the component C-1 and component C-2.

It is preferred for the monomer mixture of the components A, B and C to further contain (d) a hydroxyl-containing monomer (component D).

The component D is used to create excellent effects of enhancing the dispersion stability and increasing the highlighter-fastness in a short time just after printing. Examples thereof include 2-hydroxyethyl (meth)acrylate, 3-hydroxypropyl (meth)acrylate, polyethylene glycol (meth)acrylate (n=2 to 30; n being an average molar addition number of oxyalkylene units and the same applying below), polypropylene glycol (meth)acrylate (n=2 to 30) and poly(ethylene glycol (n=1 to 15) propylene glycol (n=1 to 15)) (meth)acrylate, with 2-hydroxyethyl (meth)acrylate, polyethylene glycol monomethacrylate and polypropylene glycol methacrylate being preferred.

The monomer mixture may further contain (e) a monomer represented by the following formula 2 (component E):

CH₂═C(R′)COO(R²O)ₚR³ (2)

wherein R¹ represents a hydrogen atom or an alkyl group having from 1 to 5 carbon atoms, R² represents a divalent hydrocarbon group having from 1 to 30 carbon atoms which may have a heteroatom, R³ represents a monovalent hydrocarbon group having from 1 to 30 carbon atoms which may have a heteroatom, the subscript p represents an average molar addition number of from 1 to 60, preferably from 1 to 30.

The component E creates excellent effects of improving the jetting stability of water-based inks and preventing the deformation of printed images even in continuous printing operations.

Examples of the optional heteroatoms for R² or R³ of the formula 2 include nitrogen atom, oxygen atom and sulfur atom.

Examples of R² and R³ include aromatic groups having from 6 to 30 carbon atoms, heterocyclic groups having from 3 to 30 carbon atoms and alkylene groups having from 1 to 30 carbon atoms, each optionally having a substituent. R² and R³ may be a combination of two or more of these groups. Examples of the substituents include aromatic groups, heterocyclic groups, alkyl groups, halogen atoms and amino groups.

Preferred examples of R² include phenylene group which may have a substituent having from 1 to 24 carbon atoms, aliphatic alkylene groups having from 1 to 30 carbon atoms and preferably from 1 to 20 carbon atoms, aromatic ring-containing alkylene groups having from 7 to 30 carbon atoms and hetero ring-containing alkylene groups having from 4 to 30 carbon atoms. Preferable examples of R²O include oxyethylene group, oxy(iso)propylene group, oxytetramethylene group, oxyheptamethylene group, oxyhexamethylene group, oxyalkylene groups having from 2 to 7 carbon atoms composed of at least one of preceding oxyalkylene groups, and oxyphenylene group.

Preferred examples of R³ include phenyl group, aliphatic alkyl groups having from 1 to 30 carbon atoms and preferably from 1 to 20 carbon atoms which may have a branched chain, aromatic ring-containing alkyl groups having from 7 to 30 carbon atoms and hetero ring-containing alkyl groups having from 4 to 30 carbon atoms, with alkyl groups having from 1 to 12 carbon atoms such as methyl group, ethyl group, (iso)propyl group, (iso)butyl group, (iso)pentyl group and (iso)hexyl group, and phenyl group being more preferred.

Examples of the components E include methoxypolyethylene glycol (meth)acrylate (p in the formula 2 is from 1 to 30), methoxypolytetramethylene glycol (meth)acrylate (p=1 to 30), ethoxypolyethylene glycol (meth)acrylate (p=1 to 30), (iso)propoxypolyethylene glycol (meth)acrylate (p=1 to 30), butoxypolyethylene glycol (meth)acrylate (p=1 to 30), octoxypolyethylene glycol (meth)acrylate (p=1 to 30), methoxypolypropylene glycol (meth)acrylate (p=1 to 30), and methoxy(ethylene glycol/propylene glycol copolymer) (meth)acrylate (p=1 to 30; p=1 to 29 for the ethylene glycol portion, with methoxypolyethylene glycol (meth)acrylate (p=1 to 30) being preferred.

Each of the components D and E may be used singly or in combination of two or more.

Specific examples of the components D and E which are commercially available include polyfunctional (meth)acrylate monomers (NK Ester) M-40G, 90G and 230G of Shin Nakamura Kagaku Kogyo Co., Ltd. and Blenmer series PE-90, 200 and 350, PME-100, 200, 400 and 1000, PP-1000, PP-500, PP-800, AP-150, AP-400, AP-550, AP-800, 50PEP-300, and 50POEP-800B of NOF Corporation.

A preferred content for each of the components A to E in the monomer mixture is as follows.

To attain a sufficient dispersion stability, the content of the component A is preferably from 1 to 50% by weight, more preferably from 2 to 40% by weight, and still more preferably from 2 to 20% by weight.

To attain a sufficient dispersion stability of the fine particles of water-insoluble polymer containing a colorant, the content of the component B is preferably from 1 to 50% by weight, more preferably from 5 to 40% by weight, and still more preferably from 5 to 20% by weight.

To attain sufficient water resistance and bleed resistance, the content of the component C is preferably from 5 to 98% by weight, more preferably from 10 to 80% by weight, and still more preferably from 10 to 60% by weight.

To attain sufficient long-term storage stability and jetting properties of resulting water-based inks, the weight ratio (A/(B+C)) of the content of the component A and the total content of the components B and C is preferably from 0.01 to 1, more preferably from 0.02 to 0.67, and still more preferably from 0.03 to 0.50.

To attain sufficient jetting properties, optical density and highlighter-fastness, the content of the component D is preferably from 5 to 40% by weight and more preferably from 7 to 20% by weight.

To attain sufficient jetting properties and dispersion stability, the content of the component E is preferably from 5 to 50% by weight and more preferably from 10 to 40% by weight.

To attain sufficient stability in water and water resistance, the total content of the components A and D is preferably from 6 to 60% by weight and more preferably from 10 to 50% by weight.

To attain sufficient dispersion stability in water and jetting properties, the total content of the components A and E is preferably from 6 to 75% by weight and more preferably from 13 to 50% by weight.

To attain sufficient dispersion stability in water and jetting properties, the total content of the components A, D and E is preferably from 6 to 60% by weight and more preferably from 7 to 50% by weight.

The water-insoluble polymer for constituting the water-insoluble polymer particles is produced by copolymerizing the above monomer mixture by a known polymerization method such as bulk polymerization, solution polymerization, suspension polymerization and emulsion polymerization, with the solution polymerization being preferred because the effects of the present invention such as high optical density and high bleed resistance can be enhanced.

The solvents for the solution polymerization are preferably organic polar solvents having a high affinity with the water-insoluble polymers, which preferably have a solubility in water of from 5 to 50% by weight at 20° C. Examples of the organic polar solvents include aliphatic alcohols such as butoxyethanol; aromatic compounds such as toluene and xylene; ketones such as methyl ethyl ketone and methyl isobutyl ketone; and esters such as ethyl acetate, with methyl ethyl ketone, methyl isobutyl ketone, toluene, xylene, butoxyethanol and mixed solvents of at least one preceding solvent with water being preferred.

The polymerization can be performed in the presence of a known polymerization initiator, for example, azo compounds such as 2,2′-azobisisobutyronitrile and 2,2′-azobis(2,4-dimethylvaleronitrile) and organic peroxides such as tert-butyl peroxyoctoate and dibenzoyl peroxide.

The amount of the polymerization initiator to be used is preferably from 0.001 to 5 mol and more preferably from 0.01 to 2 mol per one mole of the monomer mixture.

The polymerization can be performed also in the presence of a known chain transfer agent, for example, mercaptans such as octyl mercaptan and 2-mercaptoethanol, and thiuram disulfides.

The polymerization conditions of the monomer mixture vary depending on the types of the polymerization initiator, monomers and solvent. Typically, the polymerization is carried out at from 30 to 100° C. and preferably from 50 to 80° C. for from 1 to 20 h preferably in an atmosphere of inert gas such as nitrogen gas and argon gas.

After the polymerization, the produced polymer can be separated from the reaction product solution by a known method such as reprecipitation and solvent removal by distillation.

To make the dispersion stability of colorant, water resistance and jetting properties sufficient, the weight-average molecular weight of the polymer thus produced is preferably from 5,000 to 500,000, more preferably from 10,000 to 400,000, and still more preferably from 10,000 to 300,000.

The weight-average molecular weight of the polymer is measured by gel permeation chromatography calibrated by a standard polystyrene, using N,N-dimethylformamide containing 60 mmol/L phosphoric acid and 50 mmol/L lithium bromide as the eluent.

If the water-insoluble polymer has a salt-forming group derived from the monomer having a salt-forming group (component A), it is used for the production of the water-dispersion after neutralization. The neutralizing agent is selected from acids and bases according to the types of the salt-forming groups. Examples of the neutralizing agents include acids such as hydrochloric acid, acetic acid, propionic acid, phosphoric acid, sulfuric acid, lactic acid, succinic acid, glycolic acid, gluconic acid and glyceric acid; and bases such as lithium hydroxide, sodium hydroxide, potassium hydroxide, ammonia, methylamine, dimethylamine, trimethylamine, ethylamine, diethylamine, triethanolamine and tributylamine.

The degree of neutralization of salt-forming groups is preferably from 10 to 200%, more preferably from 20 to 150% and most preferably from 50 to 150%. The degree of neutralization of anionic salt-forming groups is calculated from the following formula.

{[weight of neutralizing agent (g)/equivalent of neutralizing agent]/[acid value of polymer (KOH mg/g)×weight of polymer (g)/(56×1000)]}×100

The degree of neutralization of cationic salt-forming groups is calculated from the following formula.

{[weight of neutralizing agent (g)/equivalent of neutralizing agent]/[amine value of polymer (HCl mg/g)×weight of polymer (g)/(36.5×1000)]}×100

The acid value and the amine value can be calculated from the amounts of constituting units of the polymer or can be obtained by the titration of a polymer solution in a suitable solvent such as methyl ethyl ketone.
(II) Colorant

To attain a sufficient water resistance, pigments and hydrophobic dyes are preferably used as the colorant for use in the water dispersion of the present invention, with the pigments being more preferred to meet the recent strong demand for a high lighfastness.

The pigments and hydrophobic dyes are preferably made into stable fine particles in the water-based inks by using a surfactant or a water-insoluble polymer. To achieve sufficient bleed resistance and water resistance, the pigments and hydrophobic dyes are preferably included into the polymer particles.

The pigments may be inorganic or organic. An extending pigment may be used, if needed, in combination with the pigment.

Examples of the inorganic pigments include carbon black, metal oxides, metal sulfides and metal chlorides, with carbon black being preferred particularly for black water-based inks. Carbon black may include furnace black, thermal lamp black, acetylene black and channel black.

Examples of the organic pigments include azo pigments, diazo pigments, phthalocyanine pigments, quinacridone pigments, isoindolinone pigments, dioxazine pigments, perylene pigments, perynone pigments, thioindigo pigments, anthraquinone pigments and quinophthalone pigments.

Specific examples of the preferred organic pigment include C.I. Pigment Yellow 13, 17, 74, 83, 97, 109, 110, 120, 128, 139, 151, 154, 155, 174, and 180; C.I. Pigment Red 48, 57:1, 122, 146, 176, 184, 185, 188 and 202; C.I. Pigment Violet 19 and 23; C.I. Pigment Blue 15, 15:1, 15:2, 15:3, 15:4, 16 and 60; and C.I. Pigment Green 7 and 36.

Examples of the extending pigments include silica, calcium carbonate and talc.

Any hydrophobic dyes can be used as long as the dyes can be included into the water-insoluble polymer particles. To efficiently include into the polymer, preferred are hydrophobic dyes which can dissolve into the organic solvent that is used for the production of the polymer in a proportion of 2 g/L or more and more preferably from 20 to 500 g/L (25° C.).

Examples of the hydrophobic dyes include oil-soluble dyes and disperse dyes, with the oil-soluble dyes being preferred.

Examples of the oil-soluble dyes include C.I. Solvent Black 3, 7, 27, 29, 34 and 45; C.I. Solvent Yellow 14, 16, 29, 56, 82 and 83:1; C.I. Solvent Red 1, 3, 8, 18, 24, 27, 43, 49, 51, 72 and 73; C.I. Solvent Violet 3; C.I. Solvent Blue 2, 4, 11, 44, 64 and 70; C.I. Solvent Green 3 and 7; and C.I. Solvent Orange 2.

Examples of the disperse dyes include C.I. Disperse Yellow 5, 42, 54, 64, 79, 82, 83, 93, 99, 100, 119, 122, 124, 126, 160, 184:1, 186, 198, 199, 204, 224 and 237; C.I. Disperse Orange 13, 29, 31:1, 33, 49, 54, 55, 66, 73, 118, 119 and 163; C.I. Disperse Red 54, 60, 72, 73, 86, 88, 91, 93, 111, 126, 127, 134, 135, 143, 145, 152, 153, 154, 159, 164, 167:1, 177, 181, 204, 206, 207, 221, 239, 240, 258, 277, 278, 283, 311, 323, 343, 348, 356 and 362; C.I. Disperse Violet 33; C.I. Disperse Blue 56, 60, 73, 87, 113, 128, 143, 148, 154, 158, 165, 165:1, 165:2, 176, 183, 185, 197, 198, 201, 214, 224, 225, 257, 266, 267, 287, 354, 358, 365 and 368; and C.I. Disperse Green 6:1 and 9. Among these disperse dyes, preferred are C.I. Solvent Yellow 29 and 30 for yellow dyes; C.I. Solvent Blue 70 for cyan dyes; C.I. Solvent Red 18 and 49 for magenta dyes; C.I. Solvent Black 3 and 7; and nigrosine black dyes for black dyes.

The above colorants may be used singly or in combination of two or more.

The content of the colorant in the water dispersion and in the water-based ink of the present invention is preferably from 1 to 30% by weight, more preferably from 2 to 20% by weight and still more preferably from 2 to 10% by weight, because the dispersion stability and optical density are enhanced.

To enhance the optical density, the weight ratio of colorant/polymer (solid basis) is preferably from 95/5 to 40/60 and more preferably from 85/15 to 50/50.
(III) Water Dispersion and Water-Based Ink for Inkjet Printing

The water dispersion for inkjet printing of the present invention can be produced by the following steps 1 to 4:
(1) a step of synthesizing a water-insoluble polymer by solution polymerization;
(2) a step of cleaning the water-insoluble polymer obtained in the step 1 with a solvent;
(3) a step of mixing at least the water-insoluble polymer obtained in the step 2, a colorant, an organic solvent and water, and then subjecting a resulting mixture to a dispersing treatment, to form a dispersion of water-insoluble polymer particles containing the colorant; and
(4) a step of removing the organic solvent from the dispersion obtained in step 3.

The solution polymerization and the water-insoluble polymer synthesized in the step 1 are described above, and will not be described in detail herein for the sake of conciseness.

The solvent used for cleaning in the step 2 is preferably a highly polar solvent to remove highly polar components. The polarity thereof is, in terms of solubility parameter (SP value), preferably 4.5 MPa^{1/2} or higher, more preferably 5.5 MPa^{1/2} or higher and still more preferably 6 MPa^{1/2} or higher. The upper limit of the solubility parameter is not critical. However, since it is very difficult to obtain a solvent having a solubility parameter greater than that of water, the solubility parameter of the solvent is actually limited to 12 MPa^{1/2} or lower. The dissolving amount of the solvent in 100 g of water is preferably 80 g or more, and more preferably 100 g or more at 20° C.

Examples of the solvents include acetone (4.75 MPa^{1/2}), isopropyl alcohol (5.62 MPa^{1/2}), acetonitrile (5.77 MPa^{1/2}), ethanol (6.30 MPa^{1/2}), methanol (7.09 MPa^{1/2}) and water (11.43 MPa^{1/2}), with ethanol and water being preferred. These solvents may be used singly or in combination of two or more.

The amount of the solvent used is, but not limited to, preferably from 5 to 200 times, more preferably from 10 to 100 times and still more preferably from 20 to 80 times the weight of the water-insoluble polymer to be cleaned.

In a preferred procedure of the step 2, the water-insoluble polymer, which may be a solution in the solvent used in the solution polymerization, is slowly added to the solvent under stirring. After the addition, the stirring is continued preferably at from 5 to 60° C., more preferably from 10 to 50° C. and still more preferably from 20 to 40° C. for from about 10 min to 2 h and preferably from 30 min to one hour, to extract a surface activating component, which decreases the surface tension, into the solvent from the water-insoluble polymer.

The stirring can be effected by vigorously stirring using a blade with a suitable shape which is mechanically rotated by a stirring motor, or by stirring using a rotor which is magnetically rotated. The rotation speed is preferably from 50 to 300 rpm, more preferably from 80 to 250 rpm and still more preferably 100 to 200 rpm.

After stirring, the mixture is allowed to stand fro preferably from 1 to 24 h, more preferably from 2 to 12 h, and still more preferably from 3 to 12 h to separate the water-insoluble polymer and the solvent, then the solvent is removed to complete the cleaning.

The above operation may be repeated 1 to 3 times. The solvent may be added to the water-insoluble polymer and vice versa. The cleaning step is described above by way of reprecipitation. However, it is merely an illustrative example, and the cleaning method is not limited thereto.

In a preferred procedure of the step 3, the water-insoluble polymer obtained in the step 2 is dissolved into an organic solvent, and then, the colorant, water and the optional neutralizing agent are added and mixed, to form an oil-in-water dispersion. The contents in the mixture are preferably from 2 to 50% by weight and more preferably from 5 to 50% by weight for the colorant; preferably from 4 to 70% by weight and more preferably from 10 to 70% by weight for the organic solvent; preferably from 1 to 40% by weight and more preferably from 2 to 40% by weight for the polymer, and preferably from 10 to 70% by weight water. When the water-insoluble polymer has a salt-forming group, a neutralizing agent is preferably used. The degree of neutralization is not critical, and may be selected so as to make the final water dispersion around neutral, for example, pH of from 4.5 to 10. Alternatively, the pH value may be adjusted in accordance with the desired degree of neutralization.

Preferred organic solvents for use in the step 3 may include alcohol solvents, ketone solvents and ether solvents, with those having a dissolving amount in 100 g of water ranging from 10 to 50 g at 20° C. being more preferred.

Examples of the alcohol solvents include ethanol, isopropanol, n-butanol, tert-butanol, isobutanol and diacetone alcohol. Examples of the ketone solvents include acetone, methyl ethyl ketone, diethyl ketone and methyl isobutyl ketone. Examples of the ether solvents include dibutyl ether, tetrahydrofuran and dioxane. Among these solvents, preferred are isopropanol, acetone and methyl ethyl ketone, with methyl ethyl ketone being more preferred.

The colorants usable in the step 3 are described in “(II) Colorant.”

neutralizing agent is selected from acids or bases described above according to the types of the salt-forming groups in the water-insoluble polymer.

The method for making the mixture into a dispersion in the step 3 is not particularly limited. The polymer particles are made finer so as to have a desired particle size preferably by a pre-dispersion operation and a subsequent main dispersion operation under shear stress, although such can be attained in some cases by the main dispersion operation alone.

Common mixing machines equipped with anchor blades are usable in the pre-dispersion operation. Preferred are high speed mixing machines, for example, those available under trade names of Ultradisper (Asada Tekko Co., Ltd.), Ebara Milder (Ebara Corporation), T.K. Homo Mixer, T.K. Pipeline Mixer, T.K. Homo Jettor, T.K. Homomic Line Flow and Filmics (all of Tokushu Kika Kogyo Co., Ltd), Clearmix (E-Technique Co., Ltd.) and KD Mill (Kinetic Dispersion Co., Ltd.).

The shear stress in the main dispersion operation is generated by a mixing machine such as roll mill, bead mill, kneader and extruder, or a high-pressure homogenizer of homo-valve type or chamber type, with the high-pressure homogenizer being preferred because the pigment in the mixture is made finer. The high-pressure homogenizers are available under trade names of High Pressure Homogenizer (Izumi Food Machinery Co., Ltd.) and Minilabo 8.3H Model (Rannie) for the homo-valve type, and Microfluidizer (Microfluidics), Nanomizer (Nanomizer Co., Ltd), Ultimizer (Sugino Machine Limited), Genus PY (Hakusui Chemical Co., Ltd.) and DeBEE 2000 (Nihon BEE Co., Ltd.).

In the step 4, the organic solvent is removed so as to convert the dispersion obtained in the step 3 into an aqueous system, leaving the water dispersion of water-insoluble polymer particles containing the colorant. The removal of the organic solvent is conducted by a known method such as vacuum distillation. The resultant water dispersion of water-insoluble polymer particles is substantially free from the organic solvent, and its content is preferably 0.1% by weight or smaller and more preferably 0.01% by weight or smaller.

In the water dispersion thus obtained, solid water-insoluble polymer containing the colorant is dispersed in the medium mainly composed of water. The form of the water-insoluble polymer particles containing the colorant is not particularly limited as long as the particles are formed from the colorant and the water-insoluble polymer, and can be any form, for example, a form where the colorant is encapsulated in the water-insoluble polymer, a form where the colorant is uniformly dispersed within the water-insoluble polymer and a form where the colorant is exposed to the surface of the water-insoluble polymer particles.

The water dispersion of the water-insoluble polymer particles may be directly used as the water-based ink with or without the use of additives commonly employed in the preparation of water-based inks for inkjet printing, such as wetting agents, penetrating agents, dispersants, viscosity regulators, defoaming agents, fungicides and corrosion inhibitors.

To prevent the clogging of printer nozzles and obtain a sufficient dispersion stability, the average particle size of the water-insoluble polymer particles in the water dispersion or the water-based ink is preferably from 0.01 to 0.5 μm, more preferably from 0.03 to 0.3 μm and still more preferably from 0.05 to 0.2 μm. The average particle size can be measured by using a laser particle analyzing system ELS-8000 (cumulant method) manufactured by Ohtsuka Denshi Co., Ltd. under the following conditions.

Measuring temperature: 25° C.

Angle between incident light and detector: 90°

Number of cumulation: 100

Refractive index of dispersing medium: 1.333 (refractive index of water)

Measuring concentration: about 5×10⁻³% by weight

The content of water in the water dispersion and in the water-based ink is preferably from 30 to 90% by weight and more preferably from 40 to 80% by weight.

To improve the optical density and bleed resistance, the content (solid basis) of the water-insoluble polymer in the water dispersion is from 1 to 7% by weight, preferably from 2 to 6% by weight, and still more preferably from 3 to 5% by weight.

To improve the optical density and bleed resistance, the content (solid basis) of the water-insoluble polymer in the water-base ink is preferably from 0.05 to 7% by weight, more preferably from 0.2 to 6% by weight, and still more preferably from 0.5 to 5% by weight.

To improve the optical density and bleed resistance, the surface tension of the water dispersion measured at 20° C. is 60 mN/m or higher, preferably 62 mN/m or higher and more preferably 63 mN/m or higher. The upper limit is not critical, and the surface tension is preferably 72 mN/m or lower, considering the surface tension of pure water.

Before formulated into the water-based ink, the water dispersion may be added with additives commonly used in the preparation of water-based inks for inkjet printing, such as wetting agents, penetrating agents, dispersants, viscosity regulators, defoaming agents, fungicides and corrosion inhibitors. Namely, the water dispersion of the present invention can contain such optional additives in addition to the water-insoluble polymer, the colorant and water, as long as a surface tension of 60 mN/m or higher at 20° C. is attained.

The surface tension can be regulated within the above range by any of known methods. In the present invention, this can be preferably attained by cleaning the water-insoluble polymer with a solvent in the step 2 because of its const-efficiency. In an alternative method, a water dispersion of water-insoluble polymer particles containing the colorant is first prepared through the steps 1, 3 and 4, omitting the cleaning step 2. Then, surface active components which will reduce the surface tension of the water dispersion are removed from the obtained water dispersion by ultrafiltration or dialysis, to control the surface tension within the above range.

The surface tension within the above range is attributable to the reduced amount of the surface active components derived from polymer which decrease the surface tension of the water dispersion or water-based ink. Such a surface tension within the specific range prevents the penetration of pigment particles, allowing the water dispersion and water-based ink to exhibit the intended effects. Namely, a high optical density is attained by the effect of preventing the vertical penetration, which retains pigment particles on the surface of a print medium by preventing them from penetrating into the print medium. A good bleed resistance is attained by the effect of preventing the horizontal penetration, which prevents the color-to-color bleed of deposited dots by controlling the spread of ink droplets over a print medium.

To attain a sufficient optical density and bleed resistance, the content of the water-insoluble polymer in the water dispersion is from 1 to 7% by weight and the surface tension at 20° C. of the water dispersion is 60 mN/m or higher, preferably 62 mN/m or higher and more preferably 63 mN/m or higher. In a preferred aspect of the invention, the content of the water-insoluble polymer is from 2 to 6% by weight and the surface tension is 60 mN/m or higher, preferably 62 mN/m or higher and more preferably 63 mN/m or higher. In a more preferred aspect of the invention, the content of the water-insoluble polymer is from 3 to 5% by weight and the surface tension is 60 mN/m or higher, preferably 62 mN/m or higher and more preferably 63 mN/m or higher.

The viscosity at 20° C. of the water dispersion is preferably from 1 to 15 mPa·s and more preferably from 1.5 to 10 mPa·s so that the viscosity of resulting water-based inks can be made appropriate. To maintain a good jetting properties, the viscosity of the water-based inks at 20° C. is preferably from 1.5 to 12 mPa·s and more preferably from 2 to 10 mPa·s.

The water dispersion for inkjet printing of the present invention and the water-based ink containing it provide a high optical density and exhibit a good bleed resistance.

The present invention will be described in more detail with reference to the following examples. However, the scope of the present invention is not limited to the following examples. In the following examples and comparative examples, “part(s)” and “%” are based on weight, unless otherwise noted.

### Preparation of Water-Insoluble Vinyl Polymers

### PREPARATION EXAMPLE 1

Into a reactor, 20 parts of methyl ethyl ketone, 0.6 parts of a chain transfer agent (n-dodecyl mercaptan) and the following monomers and macromer in respective amounts were charged. The contents were mixed and the reactor was sufficiently purged with nitrogen gas, to obtain a mixed solution.

Monomers and Macromer

| | |
|---|---|
| styrene | 10 parts |
| 2-ethylhexyl acrylate | 17 parts |
| 2-hydroxyethyl methacrylate | 10 parts |
| 50% styrene macromer solution | 4 parts |
| (AS-6S, trade name of Toagosei Co., Ltd.) | |
| methacrylic acid | 2 parts |

Separately, the following monomers and macromer, 2.4 parts of a chain transfer agent (n-dodecyl mercaptan), 60 parts of methyl ethyl ketone and 1.2 parts of 2,2′-azobis(2,4-dimethylvaleronitrile (V-65 of Wako Pure Chemical Industries, Ltd.) were charged into a dropping funnel, which was then sufficiently purged with nitrogen gas.

### Monomers and Macromer

| | |
|---|---|
| styrene | 10 parts |
| 2-ethylhexyl acrylate | 25 parts |
| 2-hydroxyethyl methacrylate | 10 parts |
| 50% styrene macromer solution | 16 parts |
| (AS-6S, trade name of Toagosei Co., Ltd.) | |
| methacrylic acid | 2 parts |

Under atmosphere of nitrogen gas, the temperature of the mixed solution in the reactor was elevated to 65° C. under stirring, and the mixed solution in the dropping funnel was slowly added dropwise to the reactor over 3 h. After 2 h from the completion of addition, a solution of 0.1 part of 2,2′-azobis(2,4-dimethylvaleronitrile) in 5 parts of methyl ethyl ketone was added. The resultant mixture was aged at 65° C. for 2 h and then at 70° C. for 2 h, to obtain a methyl ethyl ketone solution of a water-insoluble vinyl polymer.

A portion of the copolymer solution was dried under reduced pressure at 105° C. for 2 h to completely remove the solvent, to isolate the water-insoluble vinyl polymer.

The molecular weight measured by the method described above was 10,000.

### PREPARATION EXAMPLE 2

A 10% (solid content) solution of the water-insoluble vinyl polymer obtained in Preparation Example 1 in methyl ethyl ketone was introduced into a dropping funnel. The polymer solution was added dropwise at 20° C. into a beaker containing an aqueous solution of ethanol (ethanol:water=1:1 by weight) in an amount 4 times the weight of the polymer solution. After stirring with an agitator at 100 rpm for about 2 h, the precipitates were separated by filtration, and the aqueous solution of ethanol was removed from the separated precipitates by distillation, to obtain a cleaned water-insoluble vinyl polymer. The molecular weight measured in the same manner as in Preparation Example 1 was 10,000.

### PREPARATION EXAMPLE 3

A 10% (solid content) solution of the water-insoluble vinyl polymer obtained in Preparation Example 2 in methyl ethyl ketone was introduced into a dropping funnel. The polymer solution was added dropwise at 20° C. into a beaker containing an aqueous solution of ethanol (ethanol:water=1:1 by weight) in an amount 4 times the weight of the polymer solution. After stirring with an agitator at 100 rpm for about 2 h, the precipitates were separated by filtration, and the aqueous solution of ethanol was removed from the separated precipitates by distillation, to obtain a cleaned water-insoluble vinyl polymer. The molecular weight measured in the same manner as in Preparation Example 1 was 10,000.

### EXAMPLE 1

A mixture of 5 parts of the water-insoluble vinyl polymer obtained in Preparation Example 2, 25 parts of methyl ethyl ketone, 15 parts of carbon black (Monarch 880 of Cabot Specialty Chemicals Co., Ltd.) as a colorant, 0.6 part of a 5 N aqueous solution of sodium hydroxide and 300 parts of ion exchanged water was subjected to a dispersing treatment by passing through a microfluidizer (Microfluidics Co., Ltd.) 10 times under 200 MPa, to obtain a dispersion containing water-insoluble vinyl polymer particles containing the colorant.

The obtained dispersion was condensed by completely removing methyl ethyl ketone and partially removing water under reduced pressure at 60° C., to obtain a 20% (solid content) water dispersion of water-insoluble vinyl polymer particles containing the colorant.

The content (solid basis) of the water-insoluble vinyl polymer in the water dispersion was 5%. The surface tension was 65 mN/mm when measured at 20° C. using a tensiometer CBVP-Z (Kyowa Interface Science Co., Ltd.).

### EXAMPLE 2

A water dispersion of water-insoluble vinyl polymer particles containing the colorant was prepared in the same manner as in Example 1 except for using 5 parts of the water-insoluble vinyl polymer obtained in Preparation Example 3 in place of 5 parts of the water-insoluble vinyl polymer obtained in Preparation Example 2.

The content of the water-insoluble vinyl polymer in the water dispersion was 5%. The surface tension measured at 20° C. in the same manner as in Example 1 was 67 mN/m.

### COMPARATIVE EXAMPLE 1

A water dispersion of water-insoluble vinyl polymer particles containing the colorant was prepared in the same manner as in Example 1 except for using 5 parts of the non-cleaned water-insoluble vinyl polymer obtained in Preparation Example 1 in place of 5 parts of the water-insoluble vinyl polymer obtained in Preparation Example 2.

The content of the water-insoluble vinyl polymer in the water dispersion was 5%. The surface tension measured at 20° C. in the same manner as in Example 1 was 55 mN/m.

### EXAMPLE 3

A mixture was prepared by mixing 20 parts of the water dispersion obtained in Example 1, 8 parts of glycerol, 5 parts of polyethylene glycol (molecular weight: 800), 0.2 parts of an acetylene glycol-polyethylene oxide adduct (Acetylenol EH, trade name of Kawaken Fine Chemicals Co., Ltd.) and 66.8 parts of ion-exchanged water. The mixture was then filtered through a 25-mL needleless syringe (Terumo Corporation) equipped with a 1.2-μm pore size microfilter (acetylcellulose membrane with a 2.5-cm outer diameter manufactured by Fuji Photo Film Co., Ltd.) to remove coarse particles, thereby obtaining a water-based ink.

### EXAMPLE 4

A water-based ink was prepared in the same manner as in Example 3 except for using 20 parts of the water dispersion obtained in Example 2 in place of 20 parts of the water dispersion obtained in Example 1.

### COMPARATIVE EXAMPLE 2

A water-based ink was prepared in the same manner as in Example 3 except for using 20 parts of the water dispersion obtained in Comparative Example 1 in place of 20 parts of the water dispersion obtained in Example 1.

### EVALUATION

The water-based inks obtained in Examples 3 and 4 and Comparative Example 2 were evaluated for the optical density and the bleed resistance by the following methods. The results are shown in Table 1.
(1) Optical Density

A solid printing was made on a commercially available ordinary copying paper 4024 (Fuji Xerox Co. Ltd.) using an inkjet printer manufactured by Canon Inc. (Satera BIJ 1300 Model). After allowed to stand at 25° C. for one hour, the optical density was measured by a Macbeth densitometer (RD914 manufactured by Macbeth), and rated according to the following criteria:

⊚: optical density of 1.2 or greater

◯: optical density of 1.1 or greater and smaller than 1.2

Δ: optical density of 1.0 or greater and smaller than 1.1

X: optical density smaller than 1.0
(2) Bleed Resistance

Two 5×5 cm square solid prints in a side-by-side position were produced, with one being solid-printed in black using each of the water-based inks obtained in Examples 3 and 4 and Comparative Example 2, and the other being solid-printed in cyan, magenta or yellow using each warranted ink for the printer used. The border between black and the adjacently printed color was visually observed immediately after solid printing, and rated according to the following criteria:

◯: clear border with no black-to-color bleed.

Δ: border not clear but perceptible with some black-to-color bleed.

X: difficult to discriminate border because of significant black-to-color bleed.

TABLE 1

| | Optical density | Bleed resistance |
|---|---|---|
| Example 3 | ∘ | ∘ |
| Example 4 | ⊚ | ∘ |
| Comparative Example 2 | Δ | x |

1. A water dispersion for inkjet printing which comprises water-insoluble polymer particles containing a colorant, wherein a content of the water-insoluble polymer in the water dispersion s from 1 to 7% by weight, and a surface tension of the water dispersion is 60 mN/m or higher at 20° C.

2. The water dispersion for inkjet printing according to claim 1, wherein the water-insoluble polymer is a water-insoluble graft polymer having (a) constitutional units derived from a monomer having a salt-forming group, (b) constitutional units derived from a macromer and (c) constitutional units derived from a hydrophobic monomer.

3. The water dispersion for inkjet printing in according to claim wherein the hydrophobic monomer is a styrene-based monomers and/or an aryl ester of (meth)acrylic acid.

4. The water dispersion for inkjet printing according to claim 1, wherein the colorant is a pigment.

5. A water-based ink for inkjet printing which comprises the water dispersion as defined in claim 1.

6. A process for producing a water dispersion for inkjet printing which comprises steps of:
(1) synthesizing a water-insoluble polymer by solution polymerization;
(2) cleaning the water-insoluble polymer obtained in the step 1 with a solvent;
(3) mixing at least the water-insoluble polymer obtained n the step 2, a colorant an organic solvent and water, and then subjecting a resulting mixture to a dispersing treatment, to form a dispersion of water-insoluble polymer particles containing the colorant; and
(4) removing the organic solvent from the dispersion obtained in the step 3.

7. The process according to claim 6, wherein the solvent for the step 2 has a solubility parameter of 4.5 MPa^{1/2} or higher.

8. The water dispersion as defined in claim 1 in inkjet printing.

9. The water-based ink as defined in claim 5 in inkjet printing.
